(19) United States
(12) Patent Application Publication
(10) Pub. No.: US 2014/0003878 A1
(43) Pub. Date: Jan. 2, 2014

(54) STRAP END FITTING FOR USE IN VERTICAL MOUNTING SYSTEM FOR MOVABLE BEAMS

(71) Applicant: ANCRA INTERNATIONAL LLC, Azusa, CA (US)

(72) Inventors: Howard T. Knox, Independence, KY (US); Remco De Jong, Cincinnati, OH (US)

(21) Appl. No.: 13/915,048

(22) Filed: Jun. 11, 2013

Related U.S. Application Data
(60) Provisional application No. 61/666,225, filed on Jun. 29, 2012.

(51) Int. Cl. B60P 7/08

(52) U.S. Cl. CPC B60P 7/0807
USPC 410/104

(57) ABSTRACT

A system for supporting webbing is provided. The system includes an elongate track configured to be fixedly mounted upon a wall of a cargo compartment, the track comprising a back surface, a left lip, a right lip, a right recess disposed between the back surface and the right lip, a left recess disposed between the back surface and a left lip, and a central opening disposed between the left and right lips, wherein the track is defined from a continuous material. A strap end fitting is configured to be removably disposed upon the track, the strap end fitting comprising a base, a left finger and a right finger extending from opposite sides of the base, a keeper arm pivotably attached to the base, and a retention structure extending from the base.

### CROSS-REFERENCE TO RELATED APPLICATIONS

This application claims priority from U.S. Provisional application No. 61/666,225, filed on Jun. 29, 2012, the entirety of which is hereby fully incorporated by reference herein.

### TECHNICAL FIELD

This invention related to a cargo securement strap for use with decking systems for carrying cargo in which the deck height can be adjusted and more particularly to such a system for use in supporting freight in a vehicle compartment.

### BRIEF SUMMARY

A first representative embodiment of the disclosure provides a system for receiving a movable beam. The system includes an elongate track configured to be fixedly mounted upon a wall of a cargo compartment, the track comprising a back surface, a left lip, a right lip, a right recess disposed between the back surface and the right lip, a left recess disposed between the back surface and a left lip, and a central opening disposed between the left and right lips, wherein the track is defined from a continuous material. A strap end fitting is configured to be removably disposed upon the track. The strap end fitting comprises a base, a left finger and a right finger extending from opposite sides of the base and a keeper arm pivotably attached to the base, and a retention structure extending from the base. The strap end fitting is configured to connect with the track with the keeper arm in a withdrawn position, wherein the strap end fitting is configured to approach and engage the track such that one of the left or right fingers initially extends into the left or right recess, and then the other of the left or right finger extends into the other of the left or right recess.

Other embodiments of the disclosure will become apparent in view of the following description taken in connection with the accompanying drawings.

### BRIEF DESCRIPTION OF THE DRAWINGS

FIG. 1 is a top view of a strap end fitting as it approaches a vertically mounted track at an acute angle.

FIG. 2 is the strap end fitting of FIG. 1 removably fixed to the track.

FIG. 3 is a bottom perspective view of the strap end fitting of FIG. 1, with the arm in the biased position.

FIG. 4 is a side perspective view of the strap end fitting of FIG. 3 with the arm in the biased position.

FIG. 5 is the view of FIG. 4 with the keeper arm in the raised position.

FIG. 6 is a perspective view of the strap end fitting removably fixed to the track.

FIG. 7 is top view of a second strap end fitting as it approaches the track at an acute angle.

FIG. 8 is the strap end fitting of FIG. 7 removably fixed to the track.

FIG. 9 is side perspective view of the strap end fitting removably fixed to the track with the keeper arm in a biased position.

FIG. 10 is the view of FIG. 9 with the keeper arm in a raised position.

### DETAILED DESCRIPTION OF THE DRAWINGS AND THE PRESENTLY PREFERRED EMBODIMENTS

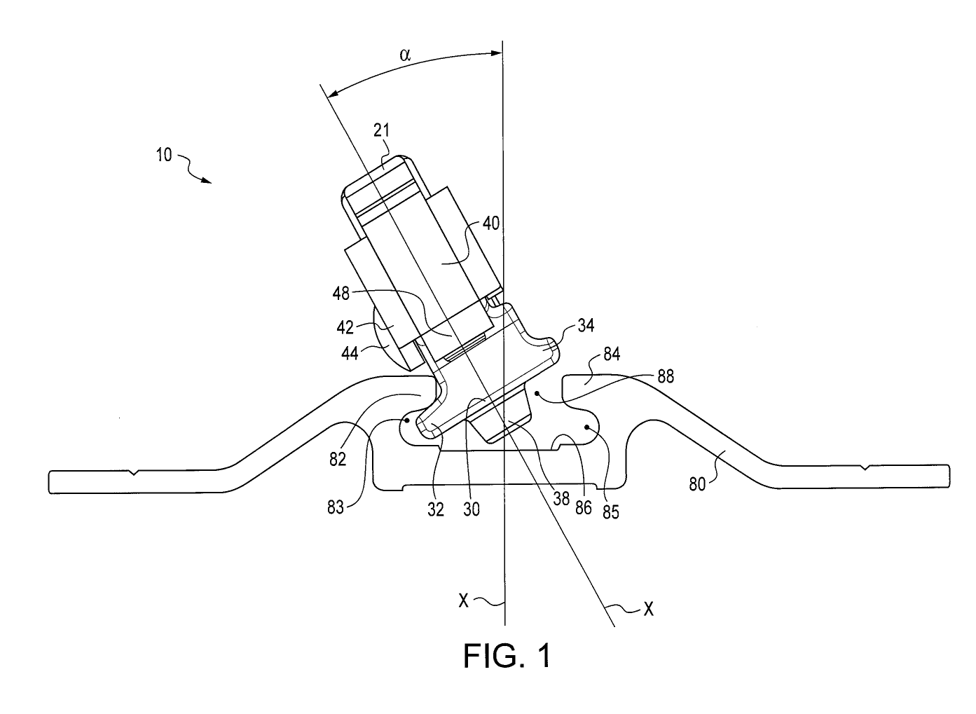

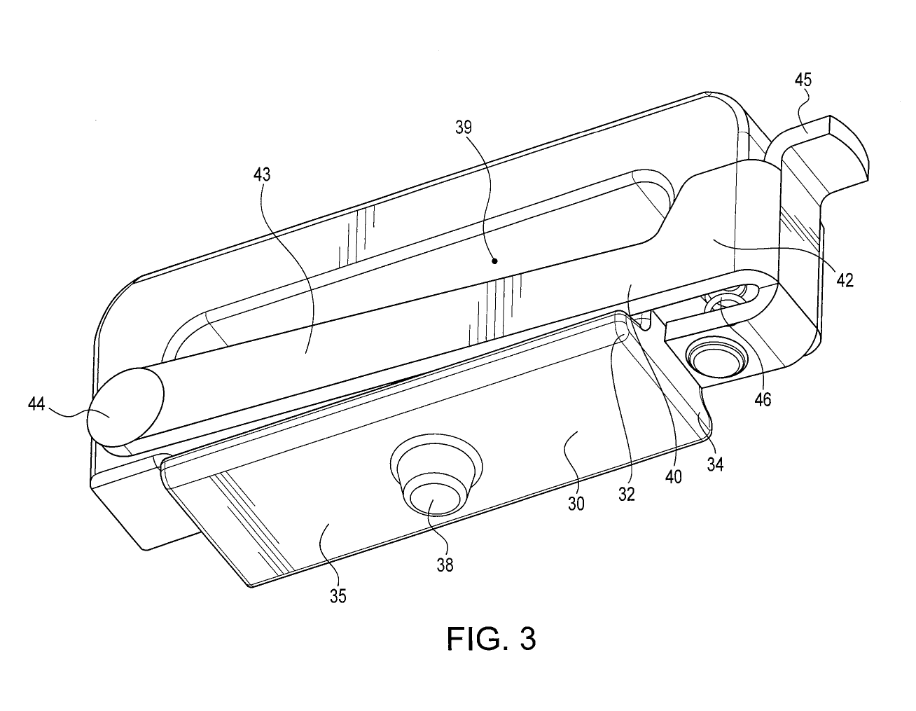

Turning now to FIGS. 1-6, an adjustable vertical retention system 10 is provided. The system 10 includes a track 80 which is normally vertically mounted to an interior wall of a cargo compartment, such as a truck trailer. In other embodiments, the track 80 may be mounted to a fixed storage location, or other types of movable cargo compartments in the transportation industry. The track 80 is normally mounted in pairs with a second track 80 that is disposed upon an opposite wall of the cargo compartment of the truck trailer (or other moving or fixed storage location). The pairs of tracks 80 are configured to support one or more beams 1000, normally horizontally mounted within the cargo compartment, which are configured to support cargo disposed therein. The beams 1000 are preferably movably mounted to opposite tracks 80 with a beam end fixedly disposed within each track 80 and rigidly mountable to each opposite end of the beam 1000. The track 80 further is configured to receive a strap end fitting 20 at a specific location thereon, with two strap end fittings 20 disposed on opposite tracks 80 to support a tightened strap therebetween to provide horizontal stability to cargo disposed upon beams 1000 or a floor structure disposed upon the beams 1000 within a cargo compartment.

The track 80 is an elongate member that may be machined, extruded, or stamped from a single piece of material, such as stainless steel or aluminum. The track 80 is a constant shape along its length, with the exception of a plurality of apertures 89 that are spacingly arranged through the back surface 86 of the track 80 along it length. In some embodiments, the plurality of apertures 89 may be consistently spaced along the length of the track 80, while in other embodiments, the plurality of apertures 89 may be at inconsistent spacings, such as at several close locations proximate to a bottom surface of the track 80, at several close locations proximate to the center of the track 80, and the like. The apertures 89 on oppositely mounted tracks 80 are normally positioned at the same heights to allow the beam 1000 disposed therebetween to be disposed horizontally at all retained positions of the strap end fittings 20 engaged with the track 80 (and fixably receiving the beam 1000).

The track 80 may further include opposed left and right lips 82, 84 with a central opening 88 disposed therebetween. In some embodiments, the left lip 82 is wider than the right lip 84 (or vice-versa), while in other embodiments, the left and right lips 82, 84 may be the same width. Each of the left and right lips 82, 84 are set off from the back surface 86 of the track with respective left and right recesses 83, 85, which are each configured to receive the respective left or right 32, 34 finger of the strap end fitting 20 when the strap end fitting 20 is mounted to the track 80. In embodiments where the left lip 82 is wider than the right lip (84) (or vice versa) the left recess 83 may also be similarly wider than the right recess 85, while in other embodiments the left and right recesses 83, 85 may be of a consistent width.

In some embodiments, the material surface forming the left lip 82 and the left recess may be formed with a continuous curve in the track 80, such that there are no corners or discrete edges formed in the track 80. Similarly, in this or other embodiments, the right lip 84 and the right recess 85 may be formed with a continuous curve in the track 80, such that there are no corners or discrete edges formed in the track 80. In some embodiments, both the left lips and recesses 82, 83, the right lip and recess 84, 85 and the back surface 86 may be formed with a continuous curve (which unites the planar back surface 86) throughout, with corners or edges formed along or between any of these features.

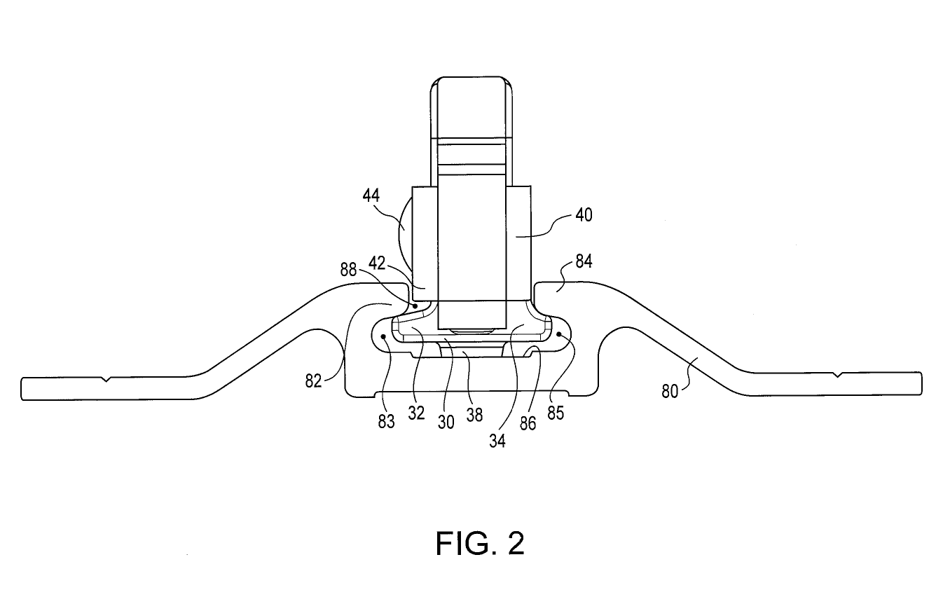

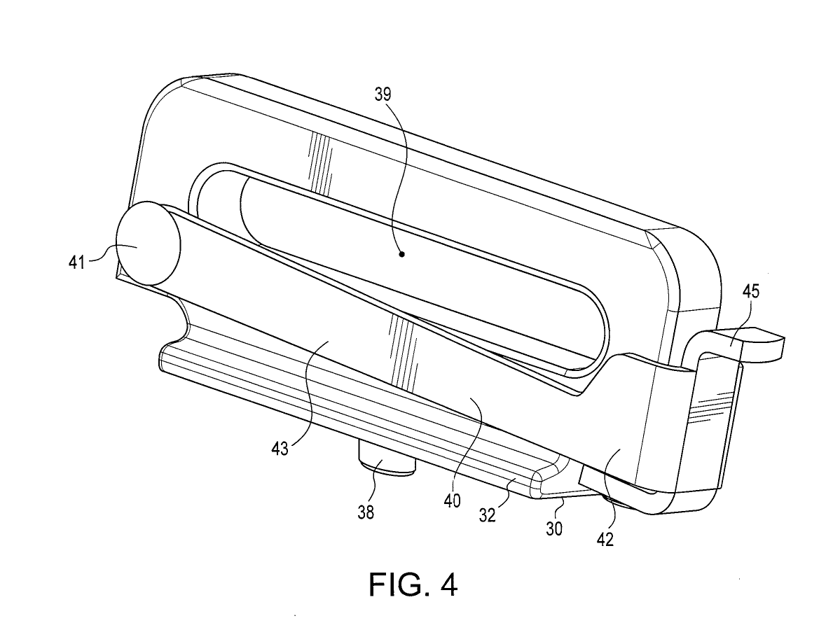

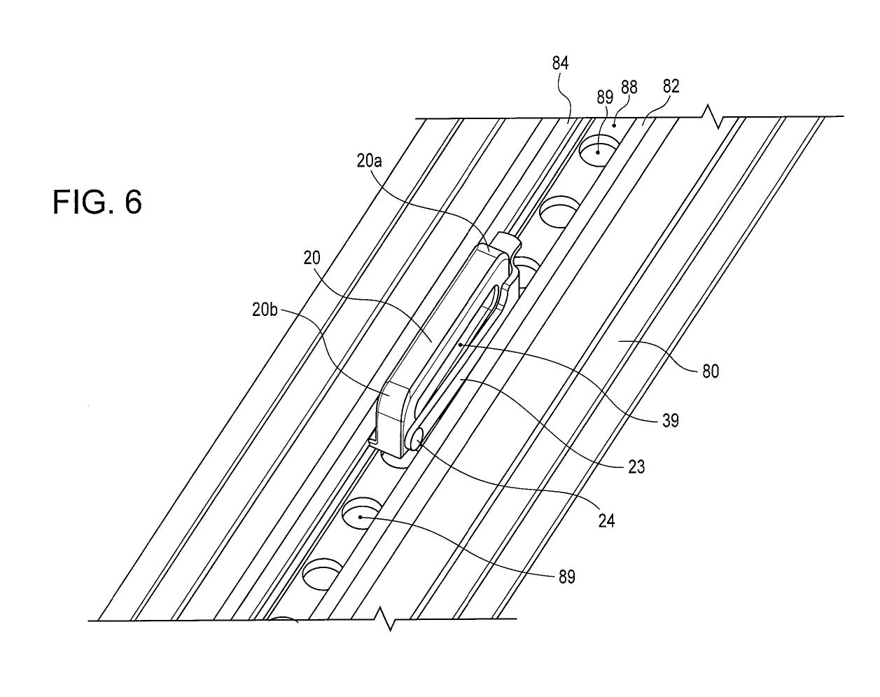

The strap end fitting 20 is configured to releasably interact with the track 80. The strap end fitting 20 includes a base 30 that forms a bottom surface of the strap end fitting 20, a body 24, and an opening 39, slot, or other retention feature that is configured to receive the cargo strap assembly webbing. The strap end fitting 20 additionally pivotably supports a keeper arm 40 with a pinned connection 44 to the body 24 of the strap end fitting 20. In some embodiments, the keeper arm 40 includes a head 42 disposed at an end of the keeper arm 40 opposite from the pinned connection 44, with the head 42 extending beyond the upper end 20a of the strap end fitting 20 (e.g. the upper end of the strap end fitting 20 when it is disposed upon the track 80, as shown in FIG. 6). The head 42 of the keeper arm 40 may include a support portion 43, which is configured to extend within the central opening 88 of the track 80 when the keeper arm 40 is in its normal biased position (FIGS. 2, 4), as discussed below.

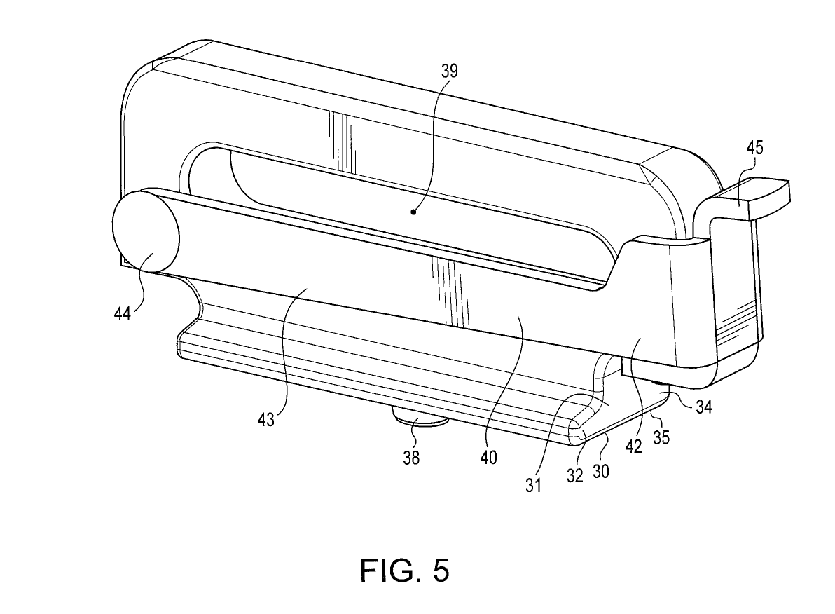

The keeper arm 40 is pivotably disposed upon the body 24 of the strap end fitting 20 and biased into a normal position by a spring 46, or other biasing member. The spring 46 may be disposed between the body 24 and a flange upon the head 42, such that the spring 46 urges in the head 42 toward the base 30 of the strap end fitting 20. The head 42 (or another suitable portion of the keeper arm 40) may include an operator 45 that is configured to allow the user to manipulate the keeper arm 40 to urge the keeper arm 40 away from the normal position, to a raised position, as best shown in FIGS. 1 and 5, against the biasing force of the spring 46. In some embodiments, the support portion 43 is disposed upwardly away from the base 30 of the strap end fitting 20 when the arm is in the raised position, and the support portion 43 is disposed away from a position where it would be received within the central opening 88 in the track 80.

The base 30 of the strap end fitting 20 includes a neck 31 that extends downwardly from the body 24 and extends along the length of the body 24, between the upper and lower ends 20a, 20b of the strap end fitting 20. With the exception of the feet 38 extending from the base 30 (discussed below), the base 30 may include the same cross-section along its length. The base may include a planar bottom surface 35 and bottom left and right fingers 32, 34 that form the respective opposite left and right sides of the base 30. The left and right fingers 32, 34 may each have a curved profile, such as forming a half circle or a smaller portion of a circle. In some embodiments, the transition from the neck 31 to one or both of the left and right fingers 32, 34 may be formed without any edges, corners or discontinuities. In some embodiments, the transition from the neck 31 to one or both of the left and right fingers 32, 34, and then to the bottom surface 35 may be formed without any edges, corners, or discontinuities.

In some embodiments, the left and right fingers 32, 34 may be symmetrical about a plane X defined through the center of the body 24 of the strap end fitting (which would extend parallel to the track 80 when the strap end fitting 20 is mounted to the track 80), while in other embodiments the left finger 32 may extend further away from the neck 31 than the right finger 34. As best shown in FIG. 1, one or both of the left and right fingers 32, 34 are positioned and sized with respect to the neck 31 such that a lip of the track 80 may extend into the space defined above the respective finger 32, 34 and be free of the neck 31 to provide clearance for the strap end fitting 20 to approach the track 80 from the side, with initial engagement between one of the fingers (such as the left finger 32 shown in FIG. 1) and the respective recess (such as the left recess 83 shown in FIG. 1) of the track 80 as the strap end fitting 20 approaches the track 80 for engagement.

The strap end fitting 20 is configured to approach the track 80 from the side with the plane X through the center of the strap end fitting 20 disposed at an acute angle a with respect to a plane Y that bisects the track 80 along its length. In some embodiments, the left finger 32 of the strap end fitting 20 is configured to extend within the left recess 83 when the plane X is at the acute angle a. Once the left finger 32 extends within the left recess 83, the right finger 34 may extend through the central opening 88, and then the strap end fitting 20 is centered with respect to the track 80. In some embodiments, when the strap end fitting 20 approaches the track 80, the keeper arm 40 is held (or locked, when a lock is provided) in the raised position such that the support portion 43 does not interact with the central opening 88 (or any portion of the track 80). After the strap end fitting 20 is centered within the track 80, the keeper arm 40 is released (and/or unlocked) and the support portion 43 extends toward and within the central opening 88. In some embodiments, the support portion 43 of the keeper arm 40 is just slightly narrower than the width of the central opening 88, such that the strap end fitting 20 is laterally stable with respect to the track 80 when disposed therein.

As discussed above, the base 30 of the strap end fitting 20 additionally includes a foot 38 that extends from the bottom surface of the base 30, and is configured to extend within one of the plurality of apertures 89 within the track 80 when the strap end fitting 20 is disposed thereon. The engagement between the foot 38 and the aperture 89 within the track 80 is configured to vertically fix the strap end fitting 20 with respect to the track, and also is configured to ensure that strap end fittings 20 that are disposed upon opposite tracks 80 are at the same vertical height (when the foot 38 of each strap end fitting 20 is disposed within an aperture 89 at the same height on opposite tracks 80), which will allow the webbing disposed thereon to be disposed at a substantially horizontal orientation.

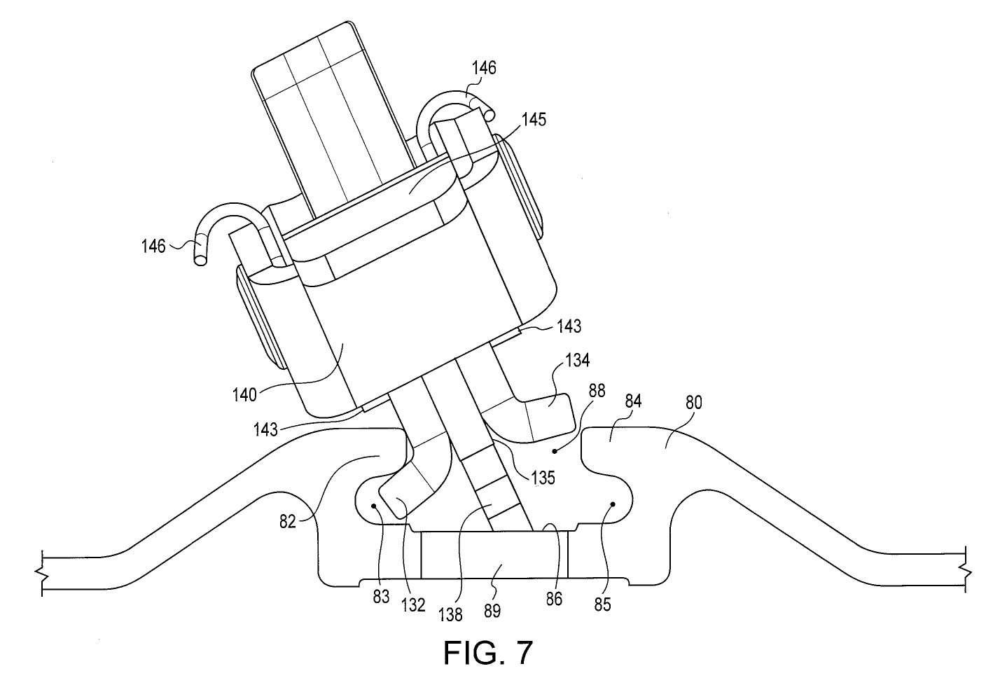

Turning now to FIGS. 7-10, a second strap end fitting 120 is provided that may be removably mounted to the track 80. The strap end fitting 120 includes a body 124 that supports a base 130, and one or more keeper arms 140, which may be disposed upon only one side of the body 124, or as shown in FIGS. 7-10, may be disposed upon both right and left sides of the body 124. The body 124 additionally includes and an opening 139, slot, or other retention feature that is configured to receive the cargo strap assembly webbing.

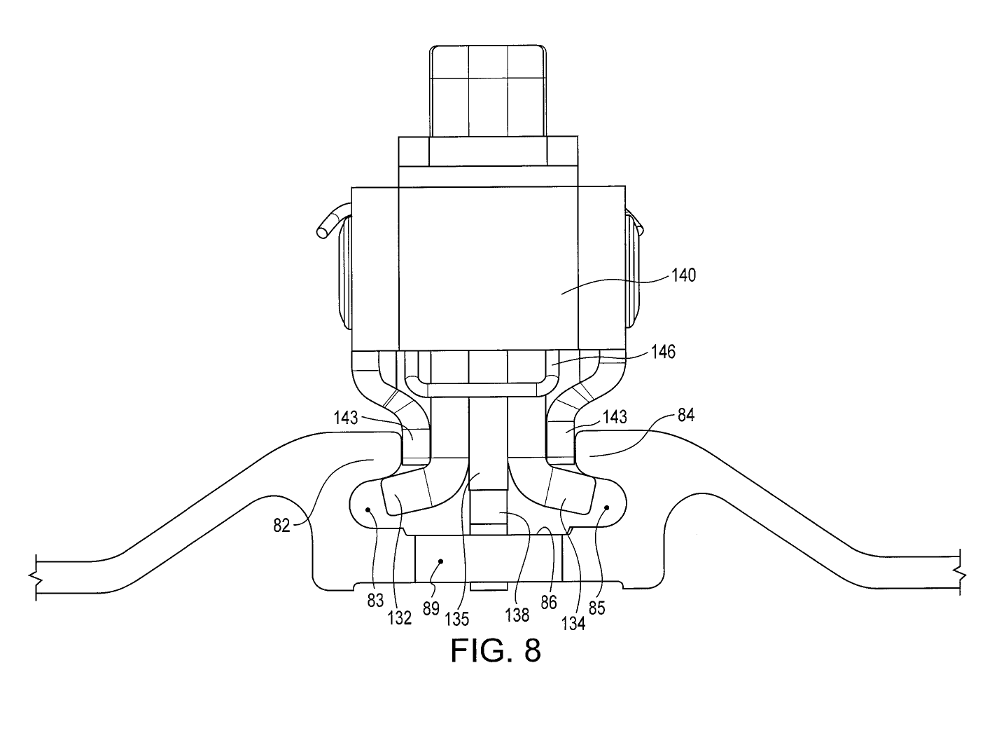

The base 130 of the strap end fitting 120 may be formed from a single component (as with the strap end fitting 20), while in other embodiments, base 130 of the strap end fitting 120 may be formed from two or three components that are fixed together. As best shown in FIGS. 7 and 8, the base 130 may be formed from a central plate 135 and from left and right plates 132, 134 that are disposed on opposite sides of the central plate 135. The left and right plates 132, 134 may include a planar neck portion 132a, 134a and a leg 132b, 134b that extends either perpendicularly or obliquely away from the neck portion. The legs 132b, 134b are each sized and shaped to be disposed within the respective left or right recess 83, 85 within the track 80 when the strap end fitting 120 is engaged with the track 80. The left and right legs 132b, 134b are each sized and shaped such that one or both may initially extend within the respective recess 83, 85 as the strap end fitting 120 approaches the track 80 from the side, as shown in FIG. 7, with the respective lip 82, 84 fitting within the empty space defined about the respective leg. As can be understood with reference to FIG. 7, once one of the left or right legs 132b, 134b is disposed within its respective recess the opposite leg 132b, 134b extends into the central opening 88 and the strap end fitting 120 ultimately becomes aligned with the track 80 with each of the left and right legs 132b, 134b disposed within their respective recess 83, 85.

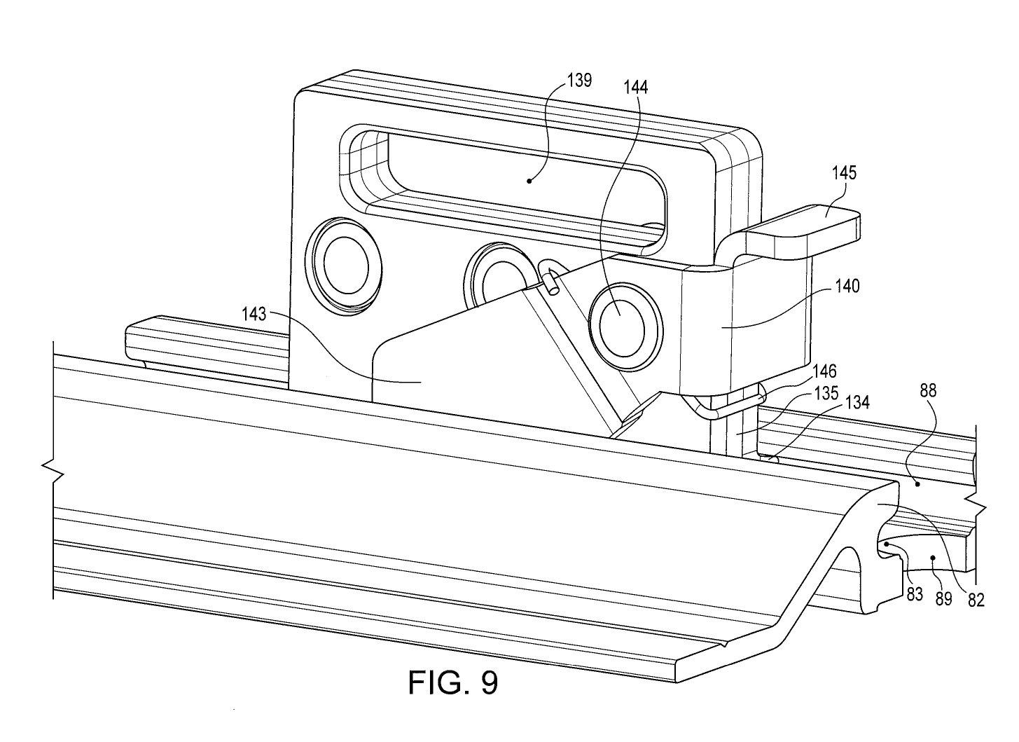

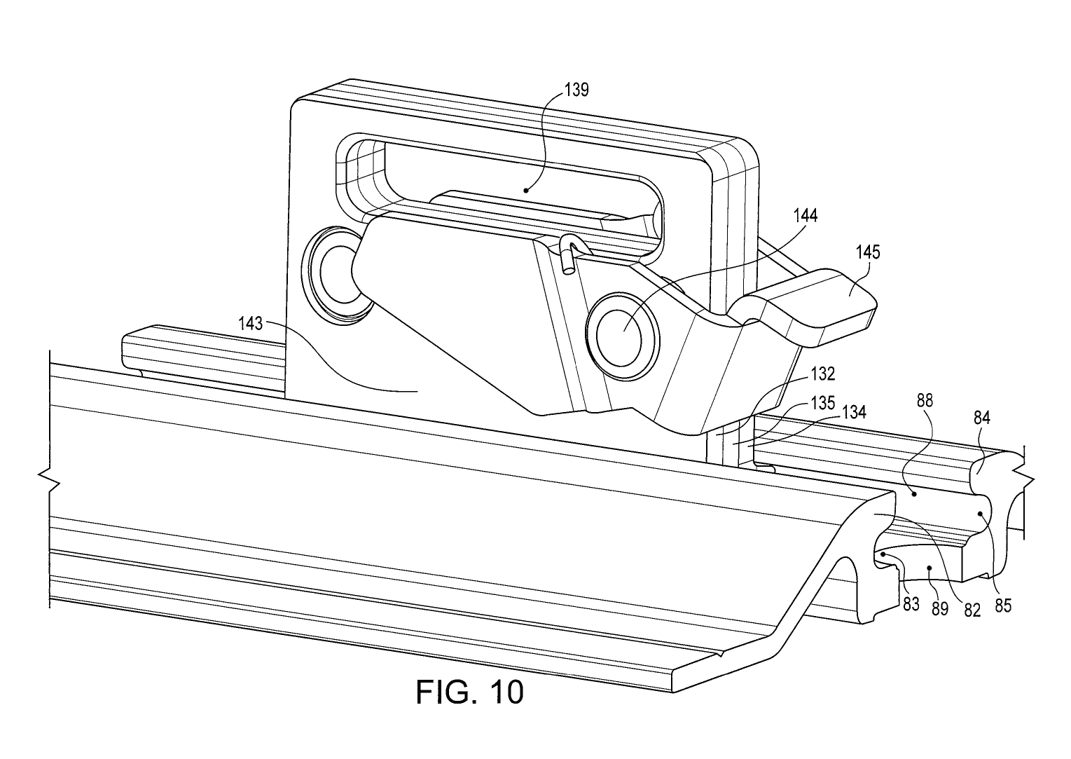

One or more keeper arms 140 are disposed upon the strap end fitting 120 and include a pinned (or other type of) connection to the body 124, a retention portion 143, and an operator 145 (or in some embodiments, a single operator 145 may be connected to both keeper arms 140). The retention portion(s) 143 are configured to extend within the central opening 88 of the track 80 when in the normal biased portion (FIGS. 8 and 9), and be withdrawn from the central opening 88 when in the raised position (FIGS. 7 and 10). The one or more keeper arms 140 are biased to the biased position with a spring 146, and the keeper arms 140 may be maintained in the raised position with a lock. In some embodiments, the keeper arm 140 may include a pivot 144 disposed between the operator 145 and the retention portion 143, while in other embodiments, the keeper arm 140 may include a pivot 144 on one end of the keeper arm 140 and the retention portion 143 on the opposite end of the keeper arm 140. The central plate 135 may include a foot 138 that extends below the bottom surface thereof. The foot 138 is configured to extend within one of the plurality of apertures 89 within the track 80 when the keeper 120 is disposed thereon. Engagement between the foot 138 and the aperture 89 provides vertical support to the strap end fitting 120 and also allows strap end fittings 120 attached to opposite tracks 80 to be easily and quickly positioned at the same heights (due to the registry between the foot 138 of each strap end fitting with the same apertures 89 on opposite tracks 80), which allows cargo webbing that is attached to opposite strap end fittings 120 to be disposed substantially horizontally.

1. A system for receiving a webbing strap comprising:
an elongate track configured to be fixedly mounted upon a wall of a cargo compartment, the track comprising a back surface, a left lip, a right lip, a right recess disposed between the back surface and the right lip, a left recess disposed between the back surface and a left lip, and a central opening disposed between the left and right lips, wherein the track is defined from a continuous material;
a strap end fitting configured to be removably disposed upon the track, the strap end fitting comprising a base, a left finger and a right finger extending from opposite sides of the base, a keeper arm pivotably attached to the base, and a retention structure extending from the base;
wherein the strap end fitting is configured to connect with the track with the keeper arm in a withdrawn position, wherein the strap end fitting is configured to approach and engage the track such that one of the left or right fingers initially extends into the left or right recess, and then the other of the left or right finger extends into the other of the left or right recess.

2. The system of claim 1, wherein the keeper arm is biased into a downward position where a head of the keeper arm is disposed between the left and right fingers within the central opening, wherein the head of the keeper arm is withdrawn from the central opening in the withdrawn position, wherein the strap end fitting is laterally fixed within the track when the arm is in the downward position.

3. The system of claim 1, wherein the strap end fitting further comprises a foot disposed upon the base between the right and left fingers.

4. The system of claim 3, wherein the track comprises a plurality of apertures spacingly arranged along the back surface, each of the plurality of apertures configured to receive the foot when the left and right fingers are disposed within the respective left and right recess.

5. The system of claim 1, wherein the left finger is longer than the right finger, wherein the strap end fitting is configured to approach the track such that the left finger initially extends into the left recess, and then the right finger extends into the right recess.

6. The system of claim 1, wherein the keeper arm is pinned to the base proximate to a first end of the base, and a head of the keeper arm is biased between the first and second fingers proximate to an opposite second end of the base.

7. The system of claim 6, wherein the head of the keeper arm extends within the central opening when the strap end fitting connects to the track and the pinned connection resides outside of the central opening.

8. The system of claim 1, wherein the respective left lip and left recess and the respective right lip and right recess are each defined by a continuous curve at the surface of the material defining the track.

9. The system of claim 8, wherein the left recess is wider than the right lip.

10. The system of claim 8, wherein the track and the strap end fitting are each configured such that the left finger of the strap end fitting initially extends within the left recess to connect the strap end fitting to the track.

11. The system of claim 2, wherein the keeper arm may be retained in the withdrawn position by a latch.

12. The system of claim 1, wherein a closest lateral distance between the left and right fingers is less than a lateral distance between a tip of the left finger of the strap end fitting and a tip of the right finger of the strap end fitting.

13. The system of claim 12, wherein the width of the head of the arm is just less than the closest lateral distance between the left and right fingers.

14. The system of claim 1, wherein the left and right fingers of the strap end fitting are defined by a single component.

15. The system of claim 1, wherein the left and right fingers of the strap end fitting are defined by two components that are affixed together.

16. The system of claim 4, wherein the base of the strap end fitting contacts the back surface of the track when the foot is received within one of the plurality of apertures.
